(19) United States
(12) Patent Application Publication
(10) Pub. No.: US 2019/0023341 A1
(43) Pub. Date: Jan. 24, 2019

(54) PIVOTING WATER BOTTLE CAGE

(71) Applicant: Wulf Investments Ltd., Edmonton (CA)

(72) Inventor: WULF Dean, Edmonton (CA)

(21) Appl. No.: 16/038,038

(22) Filed: Jul. 17, 2018

Related U.S. Application Data
(60) Provisional application No. 62/534,514, filed on Jul. 19, 2017.

(51) Int. Cl. B62J 11/00; F16B 2/06

(52) U.S. Cl. CPC B62J 11/00; F16B 2/065

(57) ABSTRACT

A pivoting water bottle cage includes a pivoting member to receive a water bottle cage, a stationary member mountable to a bike frame, and a pivot screw for attaching the pivoting member to the stationary member. A protrusion and detent cooperate to align the pivoting member and the stationary member.

### FIELD OF THE INVENTION

The present invention relates to a pivoting water bottle cage.

### BACKGROUND

Water bottle cages are used on bicycles to hold water bottles for the rider. The cage must securely hold the bottle but allow the rider to conveniently release it. Typically, the cage is installed in the bicycle frame, parallel to the plane of the frame. However, the frame size limits the size of the water bottle and the fact the bottle is inserted vertically into the cage is further limiting of the size of the water bottle.

One solution is to allow the cage to pivot out of the frame plane, but bias the cage to an aligned position using springs. This may not be convenient, reliable or sturdy enough for demanding use.

### SUMMARY OF THE INVENTION

In one aspect, the present invention comprises a pivoting water bottle cage assembly for use on a bicycle. In an embodiment, the assembly comprises:

(a) a pivoting member adapted to receive a water bottle cage;

(b) a stationary member adapted to be mounted to the bicycle frame;

(c) a pivot screw for attaching the pivoting member to the stationary member wherein the pivoting member may pivot about the pivot screw; and

(d) a protrusion and detent formed between the pivoting member and the stationary member, wherein the protrusion engages the detent when the pivoting member and the stationary member are aligned longitudinally.

### BRIEF DESCRIPTION OF THE DRAWINGS

In the drawings shown in the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 is a front view of one embodiment of the invention.

FIG. 2 is a perspective view of the embodiment of FIG. 1.

FIG. 3 is a cross-sectional view along line III in FIG. 1.

### DETAILED DESCRIPTION OF PREFERRED EMBODIMENT

The invention comprises a pivoting water bottle cage assembly for use on a bicycle. In an embodiment, the assembly comprises:

(a) a pivoting member (10) adapted to receive a water bottle cage (not shown);

(b) a stationary member (12) adapted to be mounted to the bicycle frame (not shown);

(c) a pivot screw (14) for attaching the pivoting member (10) directly to the stationary member (12) wherein the pivoting member (10) may pivot about the pivot screw (14); and

(d) a protrusion (16) and detent (18) formed between the pivoting member and the stationary member, wherein the protrusion (16) engages the detent (18) when the pivoting member and the stationary member are aligned longitudinally.

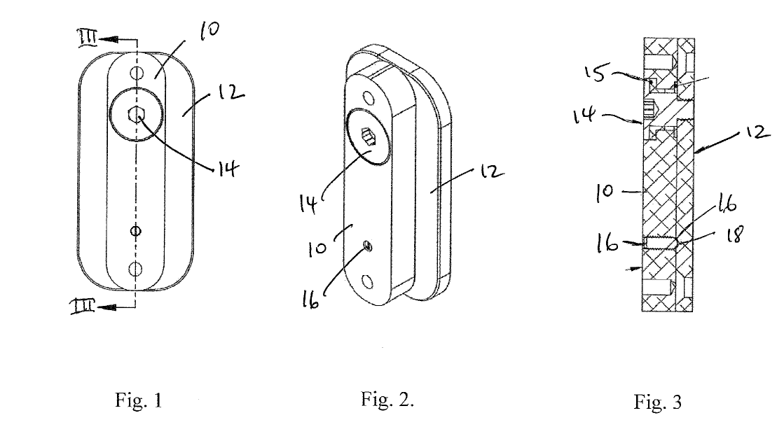

As shown in FIG. 1, the stationary member (12) has mounting holes (20) to fit screws which insert into standard cage mounts on a bicycle. Correspondingly, the pivoting member (10) has mounting holes (22) which receive screws to attach a standard water bottle cage.

The pivot screw (14) has an inner portion which threads into the stationary member (12) and a bushing (15) which engages the pivoting member (10) and allows it to rotate about the inner portion.

In one embodiment, the protrusion is comprised of a set screw ball plunger (16) which protrudes slightly from the back side of the pivoting member (10). When the pivoting member and the stationary member are aligned as shown in the drawings, the plunger (16) engages a small detent (18) formed in the stationary member. A small force is required to overcome the resistance of the plunger/detent engagement, in order to pivot the pivoting member (10) sideways. When it is returned to an aligned position, it will “click” back into position and retain the alignment of the pivoting member.

The plunger may be spring-loaded to bias the ball outwards. Alternatively, the pivot screw (14) and bushing (15) may provide sufficient free play to allow the pivoting member to bend away slightly from the stationary member, which allows the plunger to escape the detent.

The components may be made of any suitable rigid and strong material, such as aluminum, titanium, steel, plastic, carbon fiber or composite material.

Definitions and Interpretation. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the tetin “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A pivoting water bottle cage assembly comprising:
(a) a pivoting member adapted to receive a water bottle cage;
(b) a stationary member adapted to be mounted to the bicycle frame;
(c) a pivot screw for attaching the pivoting member to the stationary member wherein the pivoting member may pivot about the pivot screw; and
(d) a protrusion and detent formed between the pivoting member and the stationary member, wherein the protrusion engages the detent when the pivoting member and the stationary member are aligned longitudinally.

2. The assembly of claim 1 wherein the stationary member defines mounting holes to fit screws which insert into standard cage mounts on a bicycle.

3. The assembly of claim 2 wherein the pivoting member defines mounting holes which receive screws to attach a standard bicycle water bottle cage.

4. The assembly of claim 1 wherein the pivot screw has an inner portion which threads into the stationary member and a bushing which engages the pivoting member and allows it to rotate about the inner portion.

5. The assembly of claim 1 wherein the protrusion comprises a set screw ball plunger which protrudes from a back side of the pivoting member

6. The assembly of claim 1 comprising aluminum, titanium, steel, plastic, carbon fiber, or composite material.
